(19) United States
(12) Patent Application Publication
(10) Pub. No.: US 2018/0213127 A1
(43) Pub. Date: Jul. 26, 2018

(54) VIRTUAL PROTOCOL

(71) Applicant: The Future Group AS, Oslo (NO)

(72) Inventor: Bard-Anders KASIN, Oslo (NO)

(21) Appl. No.: 15/358,058

(22) PCT Filed: May 20, 2015
(86) PCT No.: PCT/NO2015/050085

§ 371 Date: Nov. 26, 2016

(30) Foreign Application Priority Data
May 21, 2014 (NO) 20140637

(51) Int. Cl. H04N 5/222; A63F 13/65; G06T 19/00; H04N 5/272

(52) U.S. Cl. CPC H04N 5/2224; A63F 13/65; A63F 2300/69; H04N 5/272; A63F 2300/6692; G06T 19/006

(57) ABSTRACT

A system and a method for overlaying real physical world items into a virtual simulated world, interactions between the worlds and protocols for efficient communication between these and third party participants are provided. The present invention attains the above-described objective by a studio site having real life items and a primary game engine simulating at least some of said real life items, wherein the primary game engine receives motion and position data from said studio and generates visualisation of said items, wherein the visualisation is overlaid studio images using a keyer function.

### BACKGROUND OF THE INVENTION

### Technical Field

The invention relates to special effects in general and more specifically a system and a method for overlaying real physical world items into a virtual simulated world, interactions between the worlds and protocols for efficient communication between these and third party participants.

### Background Art

From prior art one should refer to green screen technology wherein persons and items in a studio typically having green background colour (chrome key) is overlaid onto a background that can be synthetic. The problem is that the participants in the studio have no direct interaction with the background image. Also such solutions mean that there is limited scope for data compression to third party participants or plain viewers.

From prior art one should refer to the following documents:
Lang, T, et al. Massively Multiplayer Online Worlds as a Platform for Augmented Reality. Virtual Reality Conference, 2008, IEEE, side 67-70, ISBN 978-1-4244-1971-5. This relates to integration with real world and a virtual world.
US2009271821 relates to real time participation in a media presentation.
WO002873 relates to interactive TV production system with means for camera tracking.
WO2013034981 relates to a game engine at a participant.
US2002010734 relates to a networked augmented reality system
THOMAS, G. and GRAU, O. Virtual Graphics For Broadcast Production I: Computer, IEEE, 2009, Volume 6, Nr. 7, side 42-47, ISSN 0018-9162 relates to use of camera system with functionality for detecting motion and position for simulating graphics to be overlaid studio images using a keyer.

From prior art one should further refer to the following documents:
US 20050168485 relates to a method for producing composite images of real images and computer-generated 3D images using camera and lens sensor data.

### DISCLOSURE OF THE INVENTION

### Problems to be Solved by the Invention

Therefore, a main objective of the present invention is to provide a system and method that overcomes the limitations in prior art. It is an object of the invention to overcome real world physical limitations in studios. It is also an object of the invention to be able to improve data compression for transmitted multimedia. It is also an object of the invention to enable interaction of third party participants.

### Means for Solving the Problems

The objective is achieved according to the invention by a system for overlaying real physical world items into a virtual simulated world and a participating site as defined in the preamble of the independent claims, having the features of the characterising portion of said independent claims.

A number of non-exhaustive embodiments, variants or alternatives of the invention are defined by the dependent claims.

The present invention attains the above-described objective by a studio site for having real life items and a primary game engine for simulating at least some of said real life items, wherein the primary game engine receives motion and position data from said studio and generates visualisation of said items, wherein the visualisation is overlaid studio images using a keyer function.

In a preferred embodiment the system is further provided with at least one participating game engine for simulation of participating units, wherein the participating game engine receives motion and position data from the studio and generates visualisation of said items, wherein the visualisation is overlaid studio images using a keyer function.

In a more preferred embodiment the at least one participating game engine is further operable to receive data from the primary game engine.

In a further preferred embodiment the primary game engine is further operable to receive data from the at least one participating game engine

### Effects of the Invention

The technical differences over prior art using chrome key is that items and participants in the studio can interact with a background that no longer has to remain static.

These effects provide in turn several further advantageous effects:
it makes it possible to simulate items using realistic physics as well as non-realistic physics
it makes it possible to change scale between real and simulated items

The use of a participating game engine provides further advantages:
it makes it possible for participants to interact with actions in a studio, for instance in a game show viewers can take parts inside a simulated arena for the game
it makes it possible to compress data efficiently since all graphics relating to simulated items can be transferred by positional information and then rendered locally
it makes it possible to improve bandwidth not only by compression but also by preloading participating game engines prior to action

When a participating game engine receives data from the primary game engine the participant will also be able to see and optionally interact also with simulated items.

When the primary game engine is further operable to receive data from the at least one participating game engine the overall system can bring interaction from participants into the studio and make participant actions visible to each other.

### BRIEF DESCRIPTION OF THE DRAWINGS

The above and further features of the invention are set forth with particularity in the appended claims and together with advantages thereof will become clearer from consideration of the following detailed description of an [exemplary] embodiment of the invention given with reference to the accompanying drawings.

The invention will be further described below in connection with exemplary embodiments which are schematically shown in the drawings, wherein:

FIG. 1 shows and embodiment of an overall system

### DESCRIPTION OF THE REFERENCE SIGNS

The following reference numbers and signs refer to the drawings:

| | |
|---|---|
| 1000 | System |
| 2000 | Studio system |
| 2110 | Physical location motion data |
| 2120 | Physical object motion data |
| 2130 | Image data |
| 2170 | Keyer located in studio |
| 2180 | Combined result |
| 2200 | Studio site |
| 2210 | Physical location |
| 2220 | Physical object |
| 2230 | Recording means |
| 2240 | Image result |
| 2300 | Primary game engine |
| 2310 | Virtual location |
| 2320 | Virtual object |
| 2330 | Graphics engine |
| 2330 | Image result |
| 2410 | Virtual location motion data |
| 2420 | Virtual object motion data |
| 2430 | Image data |
| 3000 | Participant site |
| 3150 | Input device at participant site |
| 3170 | Multiplexer with keyer located at participant site |
| 3180 | Combined result |
| 3300 | Participating game engine |
| 3210 | Virtual location |
| 3220 | Virtual object |
| 4000 | Database system |
| 4010 | Data streams from studio site |
| 4020 | Data streams from primary game engine |

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

### Terminology

This description uses certain terms and expressions throughout the document.

Studio: a studio site and related equipment such as a primary game engine and keyer.

Studio site: a site in real life for use with physical items with means for recording such as camera and sound recording system. Preferably there is lighting and chroma key equipment.

Game engine: a physics engine that interacts with a graphics engine to visualise simulated objects in a simulated reality.

Keyer: a device that combines visual representation of physical items in a studio with visual representation of simulated items in a game engine.

### Principles Forming the Basis of the Invention

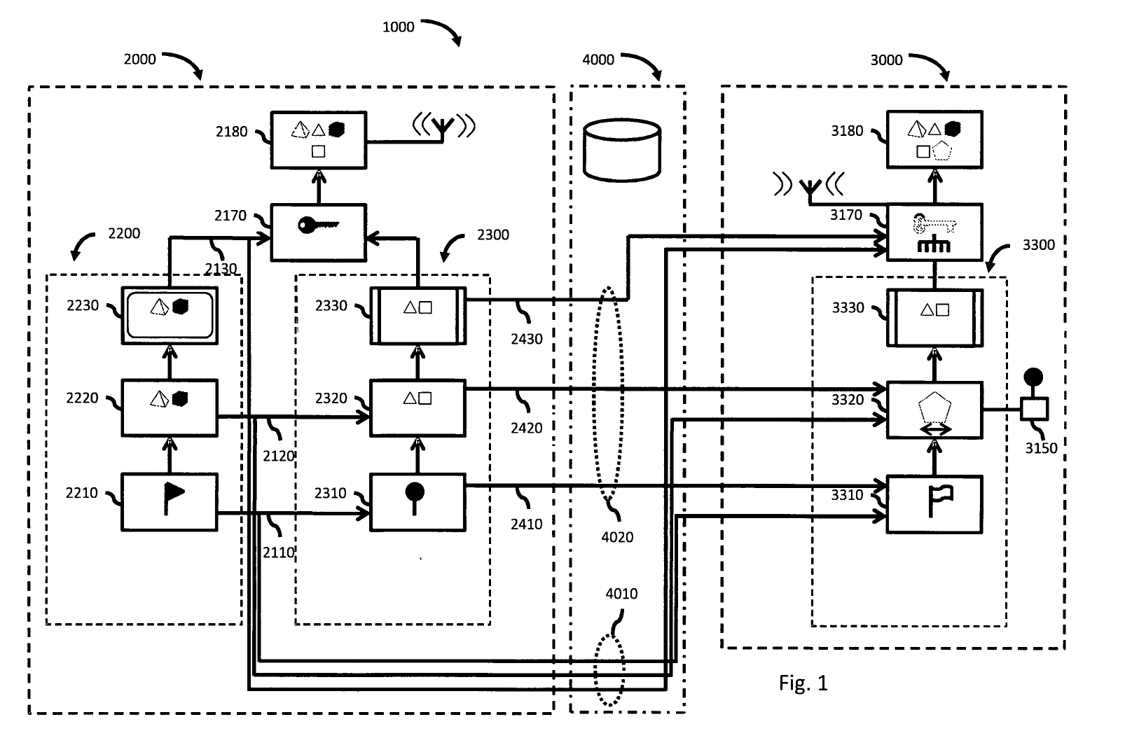

The invention will be further described in connection with exemplary embodiments which are schematically shown in the drawings, wherein FIG. 1 shows interaction between parts that make up an embodiment of the invention.

Central to the invention is the separation of real and simulated items that are integrated before presentation.

### BEST MODES OF CARRYING OUT THE INVENTION

The embodiment of the apparatus according to the invention shown in FIG. 1 comprises a system 1000 comprising a studio 2000 comprising a studio site 2200 having real life items, and a primary game engine 2300 simulating at least some of said real life items, wherein the primary game engine receives motion and position data 2110, 2120 from said studio site and generates visualisation of said items, wherein the visualisation is overlaid studio images using a keyer function.

The studio 2000 is typically comprises facilities for production of programs, shows or games. Amongst the facilities are the production site 2200 and means for producing graphical effects.

The studio site 2200 is a physical site or location in real world for use with physical items and objects with means for recording such as camera and sound recording system.

It comprises a physical location 2210 such as a scene, preferably a studio scene but can also be a location in nature or other type of on site location. The location has geometrical parameters such as a position, orientation and scaling. It is preferred that the site is provided with equipment for motion capture and thus preferably a device to record position and orientation for recording means such as camera, video and audio equipment. Data from these recording means are transmitted as physical location motion data 2110.

Related to the location there are physical items and objects 2220. These can be active objects such as humans as well as passive objects such as chairs and tables. Objects are preferably provided with means for recording and positioning of the objects, typically similarly as used in motion capture systems. Data from these recording means are transmitted as physical object motion data 2120.

Recording means 2230 record the visual and audio appearances of the objects 2220 in the studio location 2210 and generates image data 2130. Such recording means can be traditional recording means such as studio cameras and microphones. Preferably said recording means are provided with means for recording their positions with respect to the studio site so that a proper 3D representation of the scene can be determined. Note that not all objects or parts of the physical location have to be visible or recorded at all time.

Image data is transmitted to a keyer 2170 typically located in the studio 2000. The keyer is operable to overlay images from elsewhere using chroma keying. Such chroma keying is typically performed using green screens in the studio site and can be applied to the site and objects, in parts or in full.

The primary game engine 2300 provides a virtual world with simulated objects controlled by simulated physics.

The virtual world is represented by a virtual location 2310 having a location. Said location does not have to be identical with that of the physical location 2210.

The game engine receives physical location motion data 2110 so that a relationship between the positions of the real and virtual worlds can be established.

Related to the virtual world there are virtual items and objects 2320. These can be either fully virtual and simulated by the game engine, or can be simulated based on data from a physical object 2220 based on physical object motion data 2120. Such simulated object will behave similarly as the corresponding physical object when simulated using real life parameters such as mass, gravity and friction.

The game engine comprises a physics engine that handles the virtual world and related physics and simulation. The representation of the virtual world with the virtual location and the objects are rendered by a graphics engine 2330 that is also part of the game engine.

A keyer 2170 typically located in the studio receives image results 2240 from the studio site 2200 and image results 2340 from the primary game engine 2300 and combines these to a combined result 2180 that can be transmitted to viewers.

In typical use there is first a setup-phase where the positions of the real and virtual world are aligned using physical location motion data 2110. The real world scene is populated with objects whose parameters are transferred to the virtual world using physical objects motion data 2120. Cameras and other recording equipment are also objects and data about these are also transferred so that the virtual world remains in sync with the real world as cameras move, pan and zoom. Space is allocated for virtual objects, typically using green screen so that virtual objects can be overlaid into this area.

Also objects can be covered in green screen so that their visual representation can be replaced using the keyer.

Typically during the recording phase human actors move around the scene and their position is correspondingly updated in the virtual world using data 2110, 2120. The technical effect of the invention is illustrated when a human actor manipulates an object by for instance kicking a box. The box is provided with a green screen and is made invisible by the keyer. Data is however transferred to the game engine which simulates the motion of the box and replaces the real world behaviour with a rendering of a virtual box simulated with cartoon like effects such as shattering of the box and ejecting it at exaggerated velocity using appropriate visual and audio effects.

In a preferred embodiment the system further comprises a viewer at a participant site 3000 provided with at least one participating game engine 3300 for simulation of participating virtual units and objects 3320, wherein the participating game engine receives motion and position data 2110, 2120 from the studio 2200 site and generates visualisation of said items, wherein the visualisation is overlaid studio images using a keyer function.

In typical use there is first a setup-phase where the positions of the real and participating virtual world are aligned using physical location motion data 2110. The real world scene is populated with objects whose parameters are transferred to the virtual world using physical objects motion data 2120. Cameras and other recording equipment are also objects and data about these are also transferred so that the virtual world remains in sync with the real world as cameras move, pan and zoom. Space is allocated for virtual objects, typically using green screen so that virtual objects can be overlaid into this area.

Typically during the viewing phase the participating game engine receives image data and positional data from the studio system 2000 and uses these to combine image data with image results from the participating game engine in a keyer 3170 located at the participating site. This has the advantage of reducing bandwidth since image data for simulated objects can be created locally from low bandwidth motion data 2110, 2120. This also allows for local adjustment of for instance colours to improve visibility to visually impaired viewers. Locally generated image data have more bandwidth available than broadcasting systems and can therefore render images and sound in higher quality and with finer details.

In a more preferred embodiment the at least one participating game engine is further operable to receive data from the primary game engine.

In a more preferred embodiment the participant site 3000 is provided with an input device 3150 such as buttons, joysticks, keyboards, microphone and other means for entering data into the game engine 3300. This lets a viewer participate locally in a game show without relying on a centralised system that would require bandwidth for incoming user data traffic. This in turn allows for scaling up of the system.

In a further preferred embodiment the primary game engine is further operable to receive data from the at least one participating game engine. This could be motion data alone in order to conserve bandwidth while still reading in the results from participants, a solution that does not pose, the same demands of low latency as for a system where all calculations took place centrally.

In some embodiments at least some participant data can be re-broadcasted to other participants.

In other embodiments participant data could be shared between group of participants without being routed centrally, for instance by the studio.

It is preferred to direct data flows through a database system 4000 that direct the appropriate data to each participant. Such dataflow can be fata streams from studio site 4010 and data streams from primary game engine 4020.

### Alternative Embodiments

A number of variations on the above can be envisaged. For instance the studio can produce data for recording rather than live transmission.

Similarly the participant site can use recorded data rather than reception of live data. This will have the previously mentioned advantages of improved data compression.

The participant site can operate in one of several modes:

Online receive mode: wherein the participant passively views what happens in the studio,

Virtual online participation mode: wherein the participant interacts or plays with the system using the participant games engine using preferably preloaded data from the studio. This has the effect of appearing to be online without the bandwidth demand of real online and with no or limited lag. The results of the interaction are typically returned to the studio.

Full online participation mode: wherein the participant is in real time connected to the primary game engine, typically for a select few participant, Typically the system transitions from virtual participation online mode to full online participation mode for those participants doing exceptionally well and will be of a wider interest.

Playback mode: wherein the participant operates on fully preloaded data. Said data can also be the result of one of the three modes above.

### INDUSTRIAL APPLICABILITY

The invention according to the application finds use in recording, transmission, distribution and viewing of multimedia and for viewer participation.

1.-9. (canceled)

10. A system for overlaying real physical world items into a virtual simulated world comprising a studio system comprising:
a studio site for real life items and
a primary game engine comprising a physics engine for simulating at least some of said real life items,
wherein the primary game engine receives motion and position data from said studio and generates visualization of said items, wherein the visualization is overlaid studio images using a keyer function.

11. The system according to claim 10, further comprising means for transmitting motion and position data to a participating site.

12. The system according to claim 10, further comprising means for recording motion and position data for later use in a participating site.

13. The system according to claim 11, further comprising means for receiving data from the at least one participating game engine.

14. A participant site comprising:
a participating game engine comprising a physics engine for simulation of participating units,
wherein the participating game engine receives motion and position data from a studio and generates visualization of said items, wherein the visualization is overlaid studio images using a keyer function.

15. The participant site according to claim 14 wherein the at least one participating game engine is further operable to receive data from the primary game engine.

16. The participant site according to claim 14 further comprising an input device for control of the participating game engine.

17. The participant site according to claim 14 wherein the at least one participating game engine is further operable to transmit data to the primary game engine.

18. The participant site according to claim 14 wherein the at least one participating game engine is further operable to receive pre-loaded data.
